(19) United States
(12) Patent Application Publication
(10) Pub. No.: US 2005/0150408 A1
(43) Pub. Date: Jul. 14, 2005

(54) Satellite printing machine

(76) Inventor: Ebe Hesterman, Badhoevedorp (NL)

Correspondence Address: DREISS, FUHLENDORF, STEIMLE & BECKER, POSTFACH 10 37 62, D-70188 STUTTGART, DE

(21) Appl. No.: 10/497,918

(22) PCT Filed: Jul. 29, 2003
(86) PCT No.: PCT/EP03/08382

(30) Foreign Application Priority Data
Jul. 30, 2002 (DE) 102 35 872.9

(51) Int. Cl. B41F 1/30

(52) U.S. Cl. 101/409

(57) ABSTRACT

The invention concerns a digital printing machine for direct non-contact sheet printing with a digital printing mechanism with free format in the peripheral direction, and a sheet transport system which is connected downstream of the digital printing mechanism, wherein the sheet transport system has grippers at its periphery holding the sheet. Counterimpression cylinders can be integrated between the sections of transport belts for conventional printing.

The invention concerns a device for direct digital front and/or back side printing of multicolored images onto sheets using single pass methods.

Packaging and label printing are currently growing markets. The packaging market is expected to double within the next five years through the influence of Eastern Europe, South-East Asia and China, wherein plastic materials, sandwich materials and metallized substrates will be increasingly used. The worldwide turnover with packaging printing machines is about one billion Euros (Deutsche Drucker No. 4 of Feb. 6, 2003).

The packaging market poses the highest demands concerning printing and finishing quality. In jobbing (commercial printing), almost everything is printed with standard process colors, optionally extended by a customer-specific pantone color. In packaging printing many more pantone colors are (mostly) used, either exclusively or as a supplement to the process colors.

Conventional sheet-fed offset machines are classified by the maximum printable sheet format in accordance with format classes with the following variants:

| | |
|---|---|
| Small format | 353 × 500 (B3) |
| Semi-format | 500 × 707 (B2) |
| Medium format | 707 × 1000 (B1) |
| Large format | 1000 × 1414 (B0) |

In conventional sheet printing machines in accordance with the offset or letterpress printing method, image-carrying plates are used in dependence on the format class, which must be exchanged when the motive or order changes. The image or plate cylinders comprise a tensioning channel, which is also format-dependent, and mostly comprise demanding semi-automatic plate exchange systems.

For printing, it is standard to add a particular customer-specific color to the four process colors cyan, magenta, yellow and black (C, M, Y, K). The CYMK color space is likely to preclude readjustment of the pantone reference value. To obtain a larger color range (gamut) for multi-color printing, complementary red, green and blue (R.G.B) are additionally increasingly used for the 7-color HIFICOLOR system or the additional colors orange and green are used for 6 color hexachrome systems. This is advantageous in that 95% of the pantone colors can be printed without requiring the hitherto associated time-consuming cleaning of the printing mechanism for a new order. This is also confirmed by the increasing application of sheet-fed offset machines with 8 and 10 printing mechanisms, not only for double-face (duplex) 4-color printing but also for screen printing with additional colors for this so-called High-Fidelity print.

The feeding system is very precise (±0.1 mm) since the substrate sheets are aligned at standstill through side and front lay marks.

The printed sheets are transferred from the feeder pile to the first printing mechanism, from printing mechanism to printing mechanism and from the last printing mechanism to the delivery pile using gripping technology which is integrated in the counterpressure cylinder channel or in a chain carrier, in dependence on the format. This means that the separation between a gripper system and the neighboring gripper system is always equal to the maximum printing format in the peripheral direction.

Flexo lacquering mechanisms with fixed format are increasingly integrated in printing machines, since application of a lacquer layer considerably increases the value added quality of the prints, e.g. protects the printed material and improves further printing processing or e.g. spot lacquering for optical effects.

A further development concerns application of a primer (with primer in the Flexo method) before and after printing e.g. for printing plastic materials with hybrid printing systems, i.e. the combination of different printing methods in one printing machine (U.S. Pat. No. 6,443,058 B1). NIP methods for personalization (DE 100 47 040 A1), punching units (DE 101 47 486 A1) for further processing, embossing units for haptic effects (Look and Feel) and Inline Finishing (EP 80 929 091 A1) e.g. for folding have recently been- integrated in the chain of process consolidation. The above-described combination of high-quality printing, finishing and further processing methods also requires relatively demanding drying systems which results in machine lengths of up to approximately 35 meters, as reported in Druckspiegel No. 5, May 2002 SM Type CD 102 LY-6-LYYLX of the company Thomas in Gelsenkirchen as well as by COMPRESS Magazin on Apr. 6, 2003, concerning a KBA Rapida 142 sheet-fed offset machine having a format of 102×140 and a length of 37.5 meters in Illinois (USA). This machine comprises 7 offset printing mechanisms, one lacquer printing mechanism, intermediate drying and last printing mechanism, including a turning device. These highly demanding machines require i.a. expensive automation and drive concepts with e.g. double drives having toothed wheel gear trains and cardan shafts as well as several intermediate and final dryers (DE 199 12 309 A1). Without such devices, this technology could not be mastered.

Sheet turning systems are also often integrated in the sheet printing machines to print both the front and the back sides in one process.

For the above-mentioned reasons, a great amount of space is required which poses substantial problems, i.a. to a desired one-man operation, and involves new investment for the extension of the premises. In conventional applications, compact machines of satellite structure are used for small formats, with the number of printing mechanisms being limited to 4. For small, semi-, medium and large formats, modular structures for series construction are therefore frequently used which have their own construction module for each printing mechanism.

For both conventional machine concepts, format-related conventional offset or letterpress plate cylinders having tensioning channels are used. FIGS. 15 and 16 show that the use of 2×7 printing mechanisms of half-size portrait (with 345 mm diameter) would produce ergonomically unrealistic dimensions with this concept and for modular as well as satellite structures, additional modules, e.g. reel unwinding or for finishing or for further processing, are also unrealistic.

In view of the technical effort of conventional printing technologies, and due to the fact that one expects, due to the influence of “POD” (print on demand) or just-in-time production, that 90% of all jobbing and a considerable part of packaging printing orders will involve less than 5000 sheets, it becomes clear that other printing machine concepts must be invented to ensure economic future production.

For digital printing machines, a nearly offset-like quality with maximum flexibility is generally obtained in prior art, since each sheet can be continuously printed with another motive if required without losing time for adjustments and without having to change plates. For this reason, the digital printing method is well suited for printing small runs of small formats (currently max. A3 format, approximately 330×460 mm).

Most digital printing machines have paper transport systems e.g. using transport bands (DE 195 36 309 A1). Grippers are not used for transfer of the sheet (except for WO 96/17277). This limits the precision of the color register required (±0.01 mm) and the feed register (±0.1 mm). The tolerances of the feed- and transfer-register (color register) are generally larger by approximately a factor of 2 to 4 compared to printing methods using conventional feeding and gripper technology such as e.g. sheet-fed offset printing. These large tolerances (image drift) in digital printing require complicated systems to compensate for, or to attempt to compensate for, these tolerances (image drift) in inline finishing.

More digital printing machines must be used which are suitable for the POD market. The limited technical features preclude use in the graphics industry (Report Pira International Ltd. 2002 ISBN 185824641). Digital machines without grippers are mainly limited by the maximum format size, production speed, flexibility of the material to be printed and feed register.

It is therefore the object of the invention to develop a new generation of printing machines to meet the new market demands for maximum quality with minimum copies for POD and just in time systems, wherein the advantages of the conventional sheet-fed offset technology and new digital technology must be utilized to ensure future economical production. The requirements are listed below:
1. 1 to 7 digital printing mechanisms with upstream cleaning station for hexachromes or Hifi color print, using single pass methods;
2. integrated finishing with protective lacquer (100% of the packagings require protective lacquer on one side) and alternatively full-surface lacquer finishing for jobbing printing mechanisms and/or special spot effect lacquer (approximately 20 to 30% of the orders of a jobbing print are lacquered);
3. the possibility of personalization or printing of variable data;
4. a format class which is larger than the small format (approximately 36×50 cm), preferably a 50×70, 70×100 format;
5. the possibility of printing plastic material and sandwich substrates;
6. full-format duplex print on front and back side without-turning and at full production speed (for jobbing prints approximately 90% duplex is printed and for packagings approximately 5 to 10% is printed and/or finished. (e.g. rear side print with instructions, safety features or protective lacquer or coating for the inside of the packaging);
7. high-quality sheet alignment and gripper sheet transport systems for feed and transfer register, similar to sheet-fed offset, with minimum gripper change or gripper transfer;
8. high-quality arrangement of the digital printing mechanisms preferably with counterpressure cylinder of twice the periphery and delivery arrangement in the so-called 7-o'clock position to permit perfect undistorted printing (tangent function);
9. high-quality arrangement and drive of the digital printing mechanisms for extremely high register accuracy on one side for multi-color print and also between front and rear side print.
10. Straight path (minimized) sheet guidance for maximum flexibility of the material to be printed;
11. Stability with minimum operating oscillation for optimum printing quality;
12. Sheet path guidance without blotting (offsetting);
13. Good accessibility of the individual machine elements;
14. Inline finishing with exact register through gripper transfer such as e.g. hot foil embossing and/or punching and/or piling or inline folding or inline book binding;
15. Complete utilization of the synergy of common parts, modules and software of a family of printing machines for inexpensive mass production;
16. One size for one-man operation, preferably one machine length of a maximum of approximately 7 m and a machine height of a maximum of approximately 2.75 m.

CH 116 828 describes conventional offset printing mechanisms with format-dependent plate and rubber blanket cylinders which therefore both have tensioning channels. A 2×7 color printing machine of medium format is excessively large for both a satellite as well as a modular arrangement (FIGS. 15 and 16). Change of motif requires demanding plate change and in most cases rinsing (cleaning) of the printing mechanism for other customer-specific pantone colors.

Neither does DE 100 47 040 A1 discuss digital printing mechanisms, rather offset printing mechanisms which are digitally exposed online, however, using conventional plate and rubber blanket cylinders which are format-dependent and have the above-mentioned disadvantages.

DE 21 15 790 A1 also describes conventional offset and/or letterpress printing i.e. with format-related plate cylinders having tensioning channels and the above-mentioned disadvantages.

DE 199 12 309 A1 provides an example of a machine of modular structure (U.S. Pat. No. 6,443,058 B1) which is excessively long (approximately 25 m). DE 100 47 040 A1 suggests a satellite arrangement with only 4 printing mechanisms and a connected printing mechanism with coupling means required therefor. This machine disadvantageously requires a second passage for the second print (approximately 90-95% of the jobbing prints are front and back side prints) and is also not suited for 7 color print with subsequent finishing.

DE 21 15 790 A1 describes a construction or printing machine concept, which permits duplex printing in one pass but which is a combination of format-dependent plate imaging systems combined with conventional format-dependent rubber blanket cylinders. This construction does not permit integration of up to 2×7 printing mechanisms or even further modules for coating without creating unacceptable handling and engagement problems (FIG. 15). This factor is of particular importance since conventional digital printing mechanisms are based on portrait printing (i.e. printing of a page in a vertical orientation), in contrast to landscape printing in conventional sheet-fed offset printing (i.e. printing of a printed page in a horizontal orientation). Moreover, additional space must be reserved for format-related imaging cylinders or drums for access, e.g. for plate and/or rubber blanket replacement. For this reason, the maximum satellite arrangement is considered to be 4 printing mechanisms (DE 43 03 796 A1). CH 116,828 also discloses plate and rubber blanket cylinder constructions with bound format for tensioning imaging plates and rubber blankets. The format-related technology does not permit extension to 2×7 printing mechanisms with cleaning systems or even additional mechanisms for finishing.

Conventional satellite printing machines (WO 01/39976 A1) do not take into consideration the above-mentioned requirements of digital printing with regard to format-independent illustrating cylinders. Illustrating cylinders of fixed format are used which therefore cannot utilize the considerably compact construction of the inventive machine.

U.S. Pat. No. 5,016,056 discloses sheet transport without formatted gripper systems and avoids use of highly precise sheet gripper transport systems with projecting gripper backs which would damage the illustrating cylinder, by using a vacuum strip which holds the sheet on the feed side without protruding. The production tolerances of the feed register can be expected to vary by a factor of between 2 and 4—larger for the sheet feed and transport system than for printing methods using conventional gripper technology. Moreover, such systems without grippers are limited with respect to the flexibility of the material to be printed, the sheet format and the sheet thickness of the printing system. The ends of the sheet are also held by vacuum. This is disadvantageous in that only sheets of a fixed peripheral length can be printed (“secures the ends of a receiving sheet”).

DE 195 36 359 A1 discloses an endless transport without gripper systems, wherein feed and transport passer tolerances must be expected which are a factor of 2 to 4 times larger than for sheet feeder and transport systems using conventional gripper technology.

CH 116,828 provides duplex printing in one step but only at half the production speed since “a sheet must be supplied at least after every second rotation”.

In known satellite printing machines with gripper transport devices according to DE 43 03 796 A1, the number of rubber and plate cylinder pairs disposed about a printing cylinder is limited to four due to the need for access to the printing mechanisms. Front and back side printing (duplex print) therefore require sequential arrangement of two printing mechanisms or twin stations which must be connected via a turning unit as also provided e.g. in U.S. Pat. No. 5,660,108 and DE-PS-435 902.

There are various conventional concepts of digital printing mechanisms for duplex printing (front and back side printing) e.g. via a turning pocket (U.S. Pat. No. 5,552,875) (which includes the risk of distortions, paper jamming, damage, halved productivity, for limited thicknesses and is not that precise), twin installation (associated with inflexibility, large investment and many gripper transfers) or systems with half the width or half the circumference.

Turning systems are known for sheet printing machines (DE 298 07 663 U1) for printing the first and second side of the sheets (recto verso). These systems are demanding, render the machine inflexible due to their fixed position, are expensive and require a white edge (gripper edge) on both sides of the sheet. Moreover, the registering sheet guidance (turning register) is extremely difficult and leads to inaccuracies. It also limits the flexibility of the printing material with regard to substrate thickness.

For applications which only require occasional duplex printing, it is, however, feasible to integrate a conventional turning drum system, wherein the above-mentioned disadvantages must be accepted.

EP 819 268 B1 discloses a digital printing mechanism using the so-called multi-pass system, wherein the intermediate cylinder passes several times through the same printing gap and transfers the multicolored image formed on the rubber blanket cylinder onto the printing material when the sheets are supplied in cycles during the so-called single shot procedure. The associated efficiency is therefore very poor. The multiple transfer on the intermediate cylinder could have negative effects on the register accuracy e.g. through slight bulging/speed differences during multiple passage of the printing gaps. The imaging cylinder is designed for replaceable plates or cylinder milling and has a tensioning channel for tensioning or holding the plate. The so-called photo imaging plate must be regularly replaced due to wear. This construction is bound to a format and for this reason cannot receive more than 4 printing mechanisms when used in a satellite construction due to access needs (replacement of plate and rubber blanket) (DE 43 03 796 A1).

U.S. Pat. No. 6,363,234 B2 discloses a satellite construction with format-related printing mechanisms/print engines which are limited to a maximum of 4 for access reasons. A special turning technique cuts the productivity in half.

There are a plurality of digital printing techniques for transferring variable data with color onto the material to be printed. The best known methods are inkjet, thermo transfer, thermo sublimation, electro photography, magnetography, ionography and direct imaging technology (U.S. Pat. No. 3,816,840).

In the inventive machine concept, the special properties of the printing mechanism e.g. Inkjet printing is utilized in an innovative fashion in that it must not coincide with the printing length. The digital printing mechanism can be smaller than the printing length. This feature permits very compact innovative construction using gripper sheet transport systems for multi-color Hi-fi printing on the front and back sides in combination with multiple application of lacquer and with or without inline further processing in one production step (so-called single pass system) with absolutely minimum adjustment times, optimum ergonomic operating conditions (very small footprint) and inexpensive production and operation.

This non-contact printing method, is also particularly advantageous for printing sensitive substrates. When such substrates are printed with partial colors by passing with mechanical pressure (in contact) through several printing mechanisms, the substrate material can expand and thereby cause printing register inaccuracies.

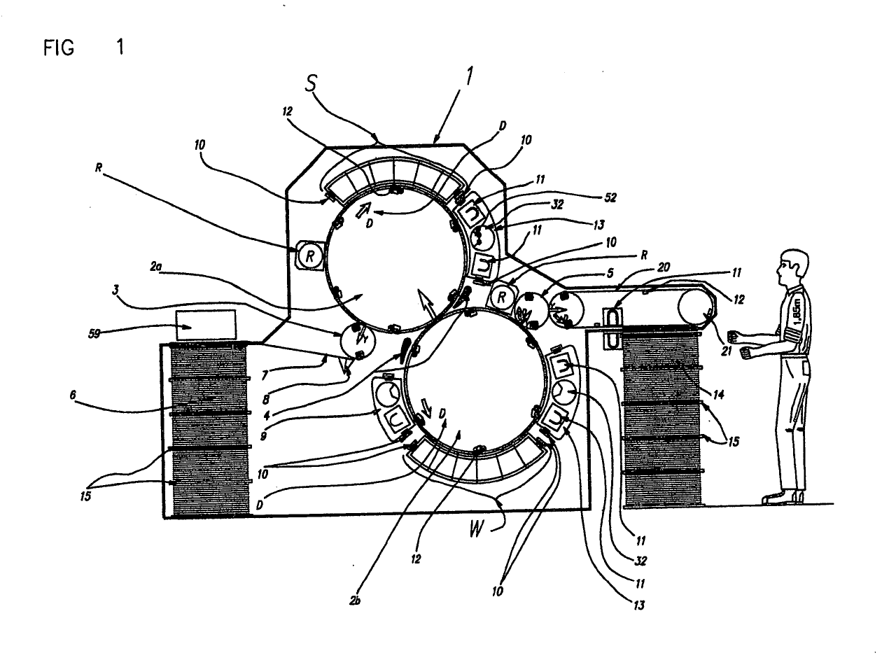

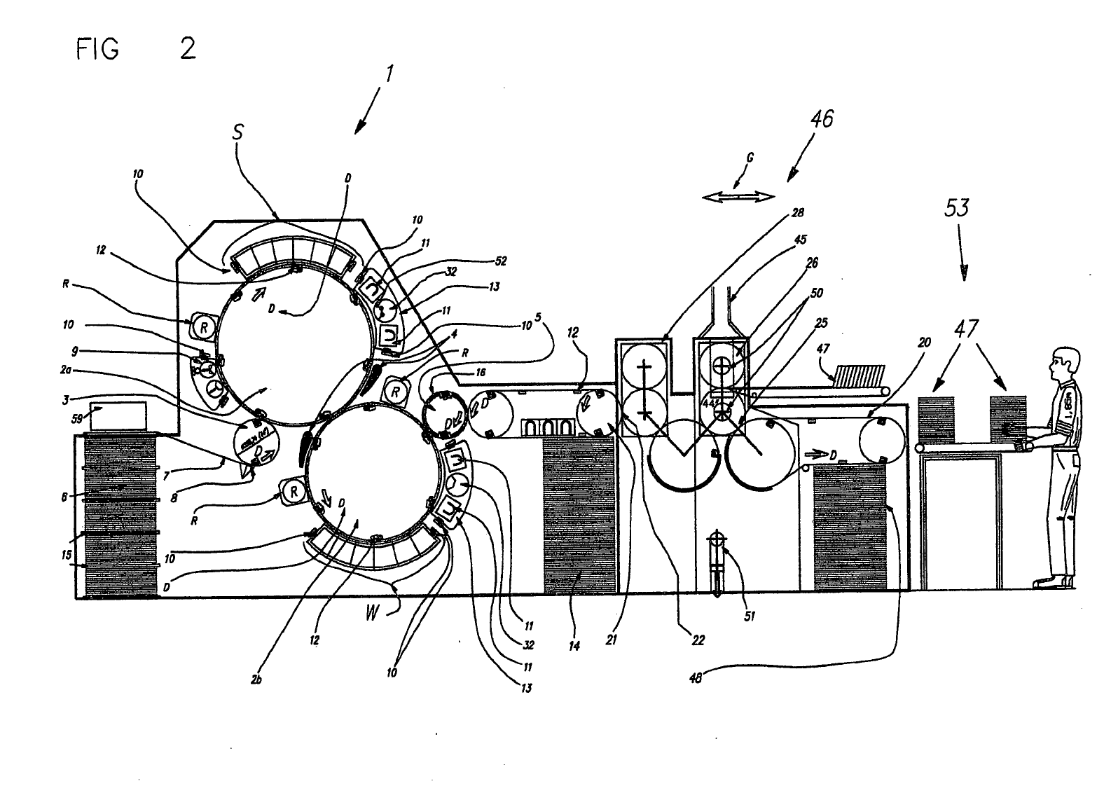

The inventive satellite printing machine has one cylinder which can be disposed centrally (see FIGS. 1 or 2) and having at least 1 to 10 associated satellite printing mechanisms for front side printing disposed, in the direction of rotation, between the supply system comprising a supply cylinder or supply rollers and the discharge system, and can cooperate with another 1 to 10 satellite printing mechanisms for back side printing. This machine construction allows one-color or multicolored front side printing and/or back side printing on sheet-shaped printing material which can be printed in one run and without additional turning technology.

In a preferred embodiment, the printing machine may be adjusted to variable thicknesses of the material to be printed via radial adjustment of the supply, printing, intermediate and discharge cylinders (arrow Y).

The compact construction of the satellite printing machine permits printing with uniform feed through conditions for the printing material which precisely passes the intermediate cylinders, appropriately registered through adjustment at standstill using conventional side and front lay marks. For this reason, the inventive satellite printing machine can achieve high cycle times and full printing speed in sheet printing, leading to high printing quality with little adjustment time. This system permits full-format printing of the front and back side printing of the printed sheet, wherein only one edge strip is required for the gripper which cannot be accessed by the printing surface of a plate cylinder periphery. This considerably reduces paper waste. The satellite printing machine can therefore also be used for printing material which is difficult to handle such as e.g. cardboard, plastic materials, multi-layer packagings or the like. This process is carried out without turning the sheets thereby obtaining more accurate register (passer) tolerances.

In an advantageous embodiment, the cylinder or chain transfer following the central cylinders is disposed in the so-called 7 o'clock position such that transfer takes place only after printing the entire sheet format to prevent the so-called tangent function during wrapping, i.e. acceleration and the associated print distortion. The 7 o'clock arrangement can be handled despite the compact dimensions of the machine, which are ergonomically specified, and the “lean” sheet guidance defined by the maximum printing material thickness.

Essential to the design of the satellite printing machine is that it is suited for simple combination with a displaceable, inline further processing station. Servomotors are preferably combined with conventional gearing in this fashion, wherein the displaceability of the finishing units is a requirement. An advantage of this processing consolidation is the increased accuracy of the finished products and reduction of additional processing means.

There are conventional digital printing machines whose flexible use is optimized through extension of the machine configuration with several paper feeder devices and sheet trays but which require a relatively large amount of space (large foot print) due to their horizontal arrangement and which require several feeder and delivery devices.

One machine concept is novel and considerably easier and compact, with which the so-called sheet trays are vertically arranged for only one single feeder and only one single delivery, with minimum machine floor space (foot print).

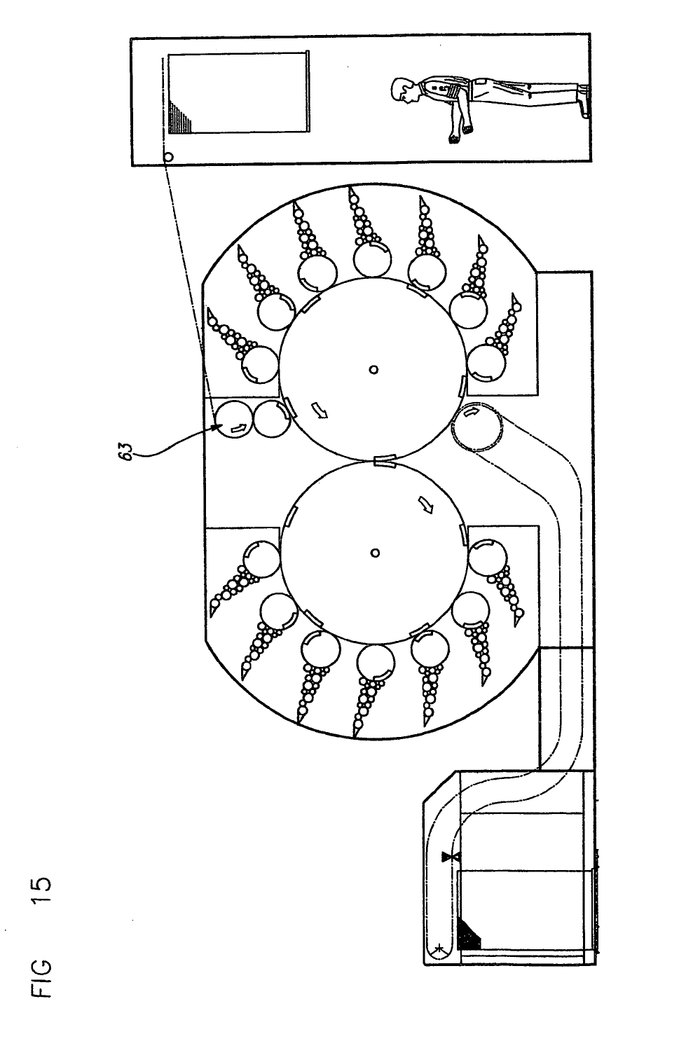

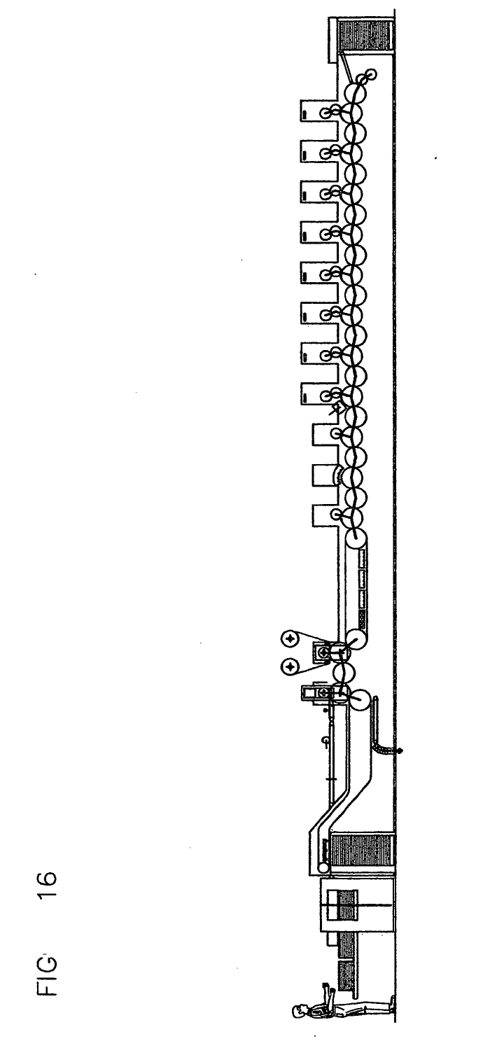

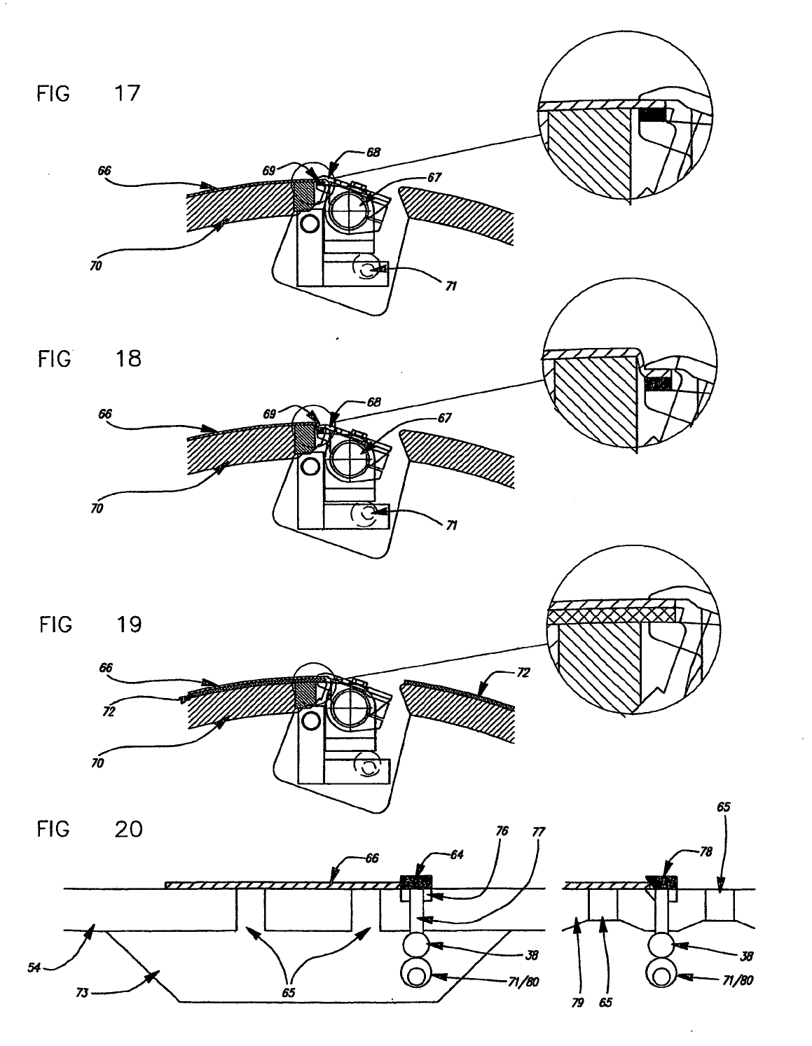

In a further inventive embodiment (FIG. 17+18), the gripper transport device can be mechanically lowered to below the cylinder surface. In doing so the digital printing mechanisms can be adjusted at a minimal distance to the cylinder surface.

The illustrated disproportionate lowering as in FIG. 18 shows the deformation of the Substrate. A further innovative detail is shown in FIG. 19, whereby the cylinder is covered with an elastic material e. g. a self-adhesive rubber blanket allowing for a minimum of deformation during the necessary lowering. Under normal conditions, the inkjet heads are positioned approximately 0.8 to 1 mm distance from the substrate. The elastic cover should allow for a lowering of the grippers of 1 up to 2.2 mm with minimal deformation of the substrate in conjunction with a gripper back of 2 to 3 mm. This deformation occurs at any rate in the non-printing zone, in the so called gripper edge, so that no extra waste is produced. In addition to the compressible elastic layer, spring type elements can also be provided. It shows, as an alternative for the transport cylinder, an innovative vacuum transport belt with so called vacuum grippers with sheet stoppers, which can be lowered. The stopper can, e. g. with state of the art eccentrics, be commanded in such a way that the stoppers are lowered during the printing process only. At that moment the sheet will be held from the vacuum system underneath the perforated transport belt, so that the sheet cannot displace. It is feasible that the stoppers are lowered with: a tilting and/or turning movement.

The required precision of the linear movement of the transport belt should be within the ±0.05 mm tolerance. This kind of precision can be obtained with transport cylinders, however not with today's transport- or timing belts. It is feasible that the transport system is designed in such a fashion that transport- and/or timing belts are driven with an exact sequenced speed in the machine. In that case the belt will be driven with a servo drive and therefore the deviations can be corrected: the deviations in the belts are compensated for by the servo drive motor. The servo drive motor does not run linearly but slower in a controlled fashion so that a constant forward correction is applied.

The fixing of the sheet to the vacuum belt can be securely designed such as in state of the art sheet turnover systems. This is a matter of design.

In an advantageous embodiment, the transport system is divided in multiple sections in order to comply with the various demands as set for by e. g. printing and drying. With drying one should compensate for the radiation and heat where as with digital printing the highest precision in linear transportation is required.

In an advantageous embodiment, the printing section (that is only being used for non contact printing, e. g. inkjet printing) features only a precise drive with automatic correction.

For UV-Drying e. g. special belts are, as state of the art suitable for use with high radiation and still suitable for ample vacuum buildup. These type of belts are however not precise enough for digital printing.

In order to obtain an optimal transfer, the feeding and delivery drum are positioned at a maxim height in relation to the transport belt.

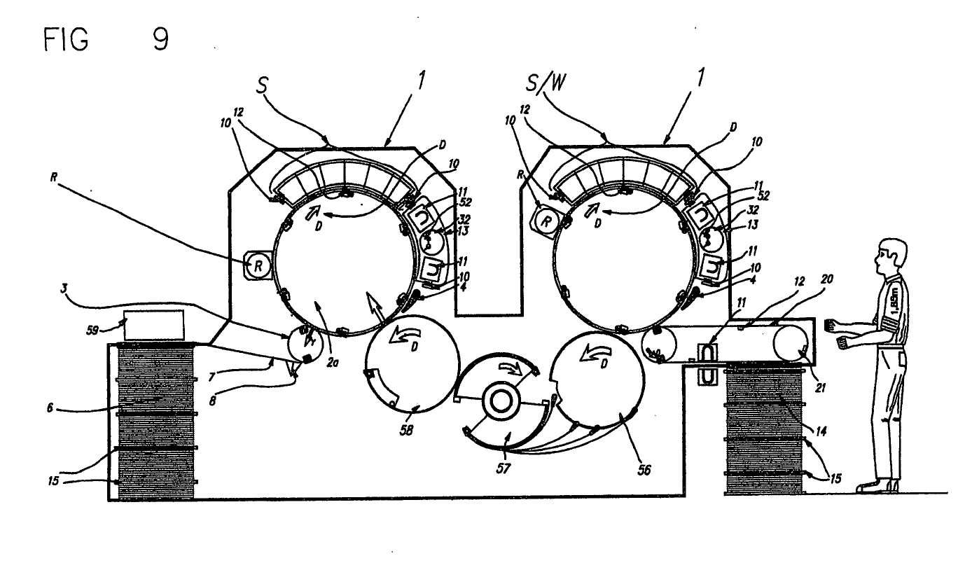

The transport belt features mechanical grippers and/or suckers (as in a conventional sheet turnover system). The transfer from the mechanical grippers to the vacuum gripper requires support from suckers, as it is state of the art with existing sheet turnover systems 56, 57, 58 from FIG. 9.

The transfer of the sheet with a so called swinging gripper 7 is not as suitable as the pusher type feeding system 81. The pusher type feeding system positions the sheets directly on the vacuum belt. In the application of the swinging grippers, there are grippers required in the transfer drum 75 or in the vacuum belt/drum.

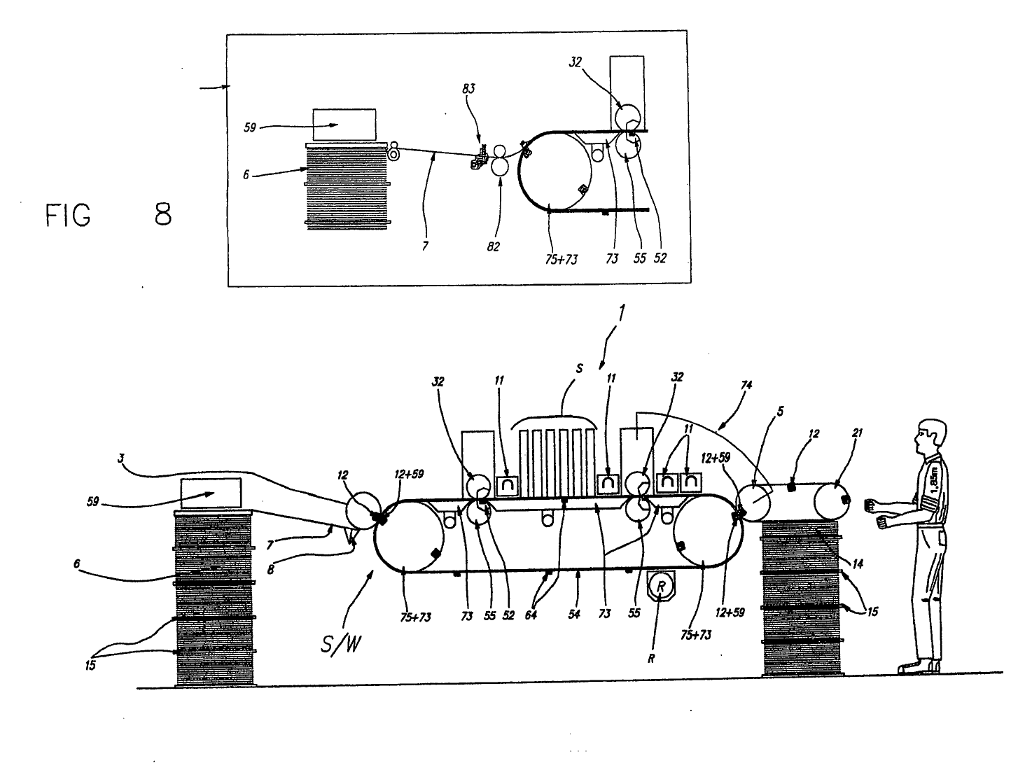

In this advantageous embodiment with a pusher type feeder of FIG. 8, no grippers are required. The sheet of material is pushed against the stopper and positioned, at the same time, very precisely with a tolerance of ±0.05 mm in peripheral direction and sideways with a precision of ±0.4 mm. When the stopper has only 0.5 mm height it still works with substrates of 0.3-0.4 thickness. Conventional sheet covers are thereby required between the stoppers (not shown).

When conventional printing units are also required e. g. for coating with the Flexo-letter press technique, format related support rollers will be provided in order to stabilise the vacuum belt and/or to function as an indirect counter impression cylinder (underneath the transport belt) These support rollers feature gripper recess clearances.

Conventional transport belts or multiple mutually adjacent fan belts can also be provided. State of the art is a mechanical type of gripper. This type of gripper system is not as suitable, since the digital printing mechanisms must be positioned at a distance from the substrates above the height of the gripper backs whom are necessarily positioned above the surface the transport system. This would mean that every printing mechanism would require support rollers with gripper recess clearance(s) which, in turn, would lead to longer transport belts. Longer transport belts tend to be instable and require, as a disadvantage, more floor space.

The patent document US 2002/00980017 shows the use of digital printing mechanisms having different constructions for front and back side printing. A further inventive embodiment is the uniform construction of the imaging cassettes for both front and back side printing in that they or the machine is/are prepared in terms of construction e.g. drive, tube connection etc. for mounting, from the drive side and also from the operating side to permit uniform construction also for both front as well as back side printing.

In the novel satellite printing machine, the printing mechanisms for front and back side printing can be sequentially disposed with or without surface drying. One complete printing unit is installed per individual color separation and therefore, the color copies are printed in the so-called SINGLE PASS SYSTEM in front and back side printing. At the input and/or output of the transport systems, several variants and additional steps can be integrated before and/or after digital printing e.g. in the cassette units e.g. for conditioning, coating, lacquer application, special print, fixing (fusing), drying and subsequent moistening. One single feeder and one single delivery can exchange various material to be printed in the paper pile in an easy and non-stop fashion using paper cassettes, so-called sheet trays. For optimum operating ease, the printing and conditioning systems are disposed in the cassette inserts. This provides optimum accessibility to the working position within the machine frame and in the service position outside the machine frame, on the operating and/or drive side.

One particularly advantageous effect of this innovative printing machine and method is the particularly low energy consumption, which is estimated to be only approximately 20% of the consumption of the conventional printing machines with drives for 35 meters of length, intermediate and end dryers, and temperature-control systems for the printing mechanisms.

A further aspect of the invention is the integration of a corona treating system in the machine to permit use of plastic materials and/or metallized and/or sandwich materials without pre-treatment.

A dryer 11 is provided on the delivery side. Further transfer drums (not shown) can be inserted between the two counter pressure cylinders. A chain transfer (not shown) could be inserted between the two counter pressure cylinders e.g. for intermediate cooling.

The presented arrangement with 6 printing mechanisms is to be considered as a basic embodiment of this compact construction. If further printing mechanisms are required, individual posts with conventional and/or digital print could be placed upstream or with a multi-color frame. Possible inline finishing (converting) may standardize the complete production of the finished products, which are e.g. punched, stamped, perforated, folded and cut.

The underlying purpose of the invention is achieved by a digital printing machine which comprises the features of claim 1.

Further details and advantageous effects of the invention can be extracted from the following description and the drawings which show embodiments of the inventive satellite printing machine.

FIG. 1 shows a side view of the inventive satellite print machine with 2 central transport cylinders and with, satellite printing mechanisms, distributed about the circumference, for front- and backside printing including a feeder and a delivery, both featuring sheettrays;

FIG. 2 shows a side view like FIG. 1 however with enlarged upper transport cylinder featuring pre-print and post-print finishing cassettes and an inline converting system;

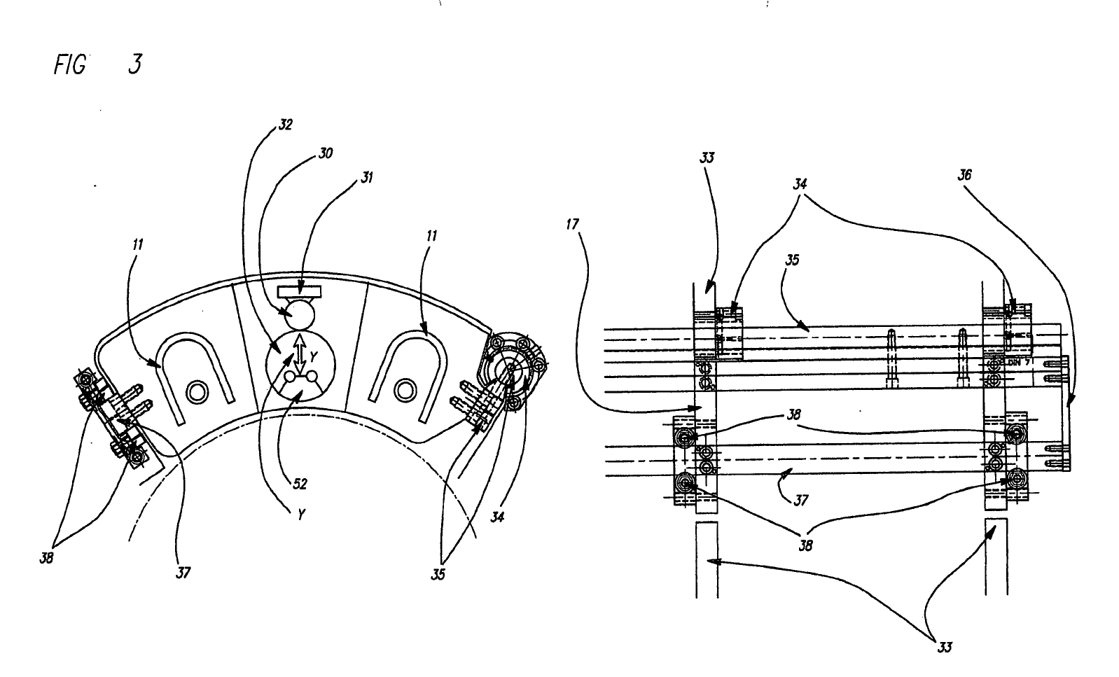

FIG. 3 shows an enlared sectional view of one of the cassette systems for finishing;

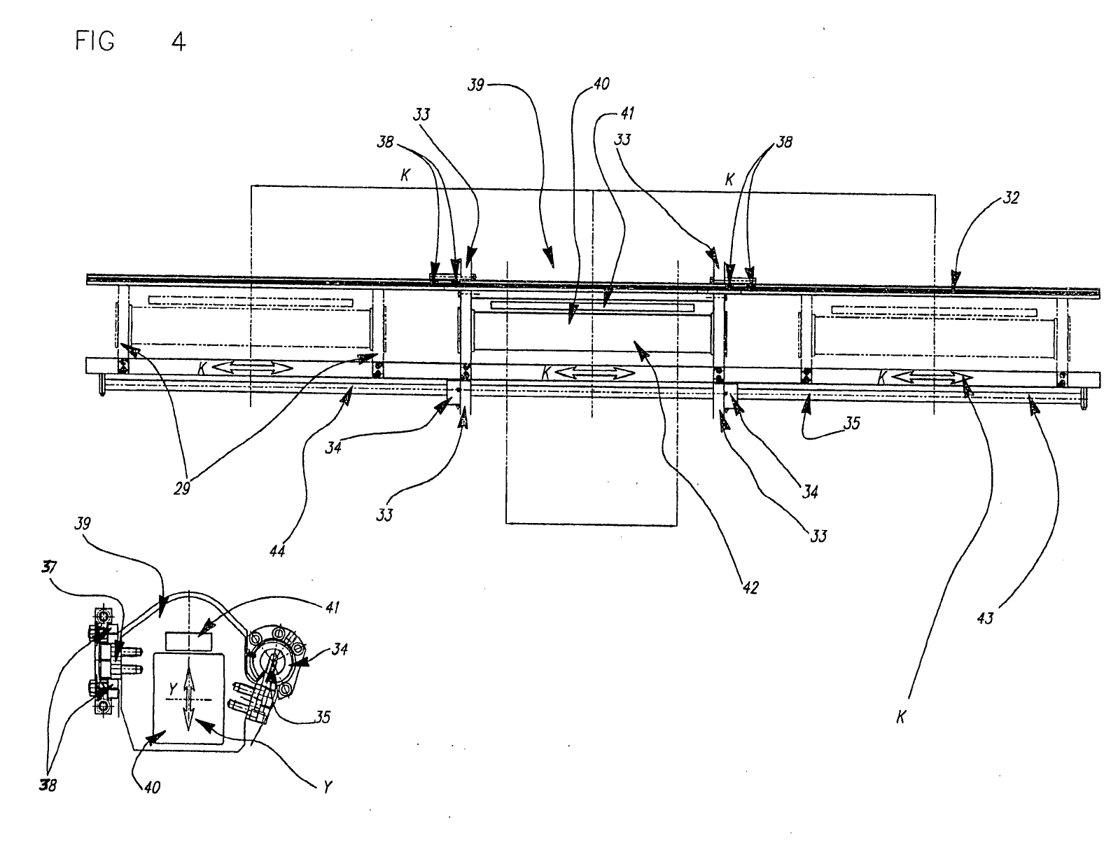

FIG. 4 shows a view of the imaging cassette in several working positions;

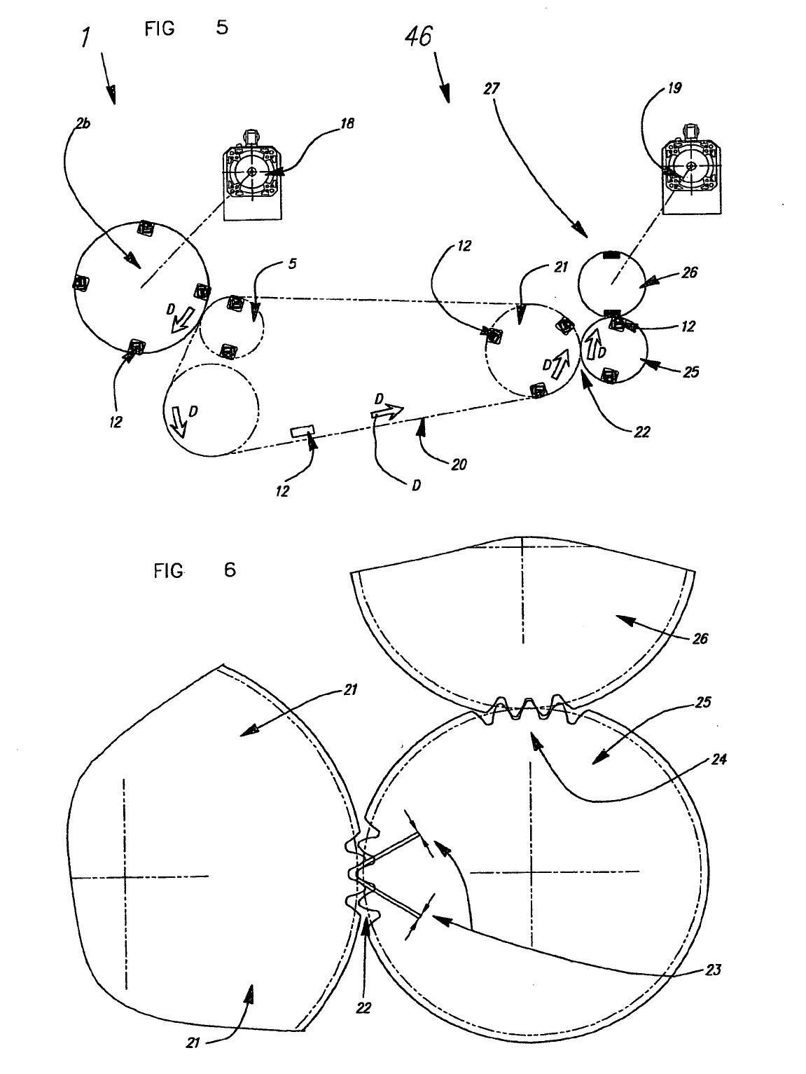

FIG. 5 and FIG. 6 show a schematic illustration of the inventive satellite printing machine with a drive concept in the area of the sheet delivery;

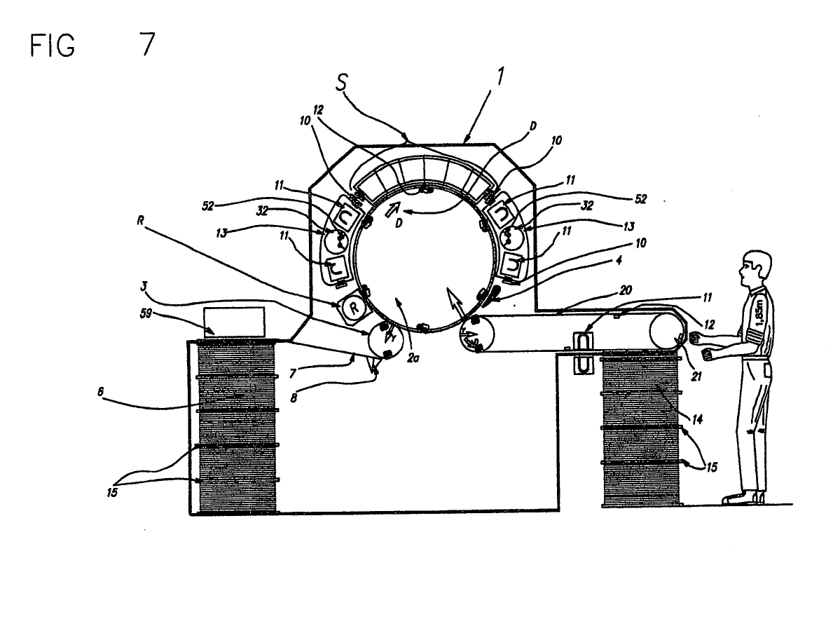

FIG. 7 shows a side view like FIG. 1 however with only one transportcylinder;

FIG. 8 shows a side view like FIG. 7 however with transport belt instead of transport cylinder, and alternatively a pusher type of feeder;

FIG. 9 shows a side view like FIG. 7 however in the twin configuration;

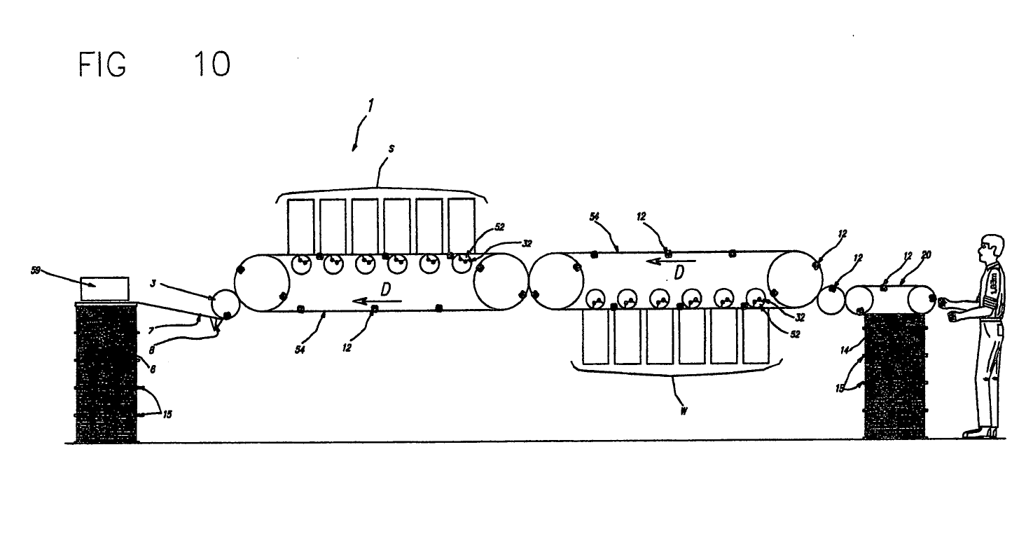

FIG. 10 shows a side view like FIG. 8 however in the twin configuration;

FIG. 11 shows a side view like FIG. 10 however with a sheet turnover system;

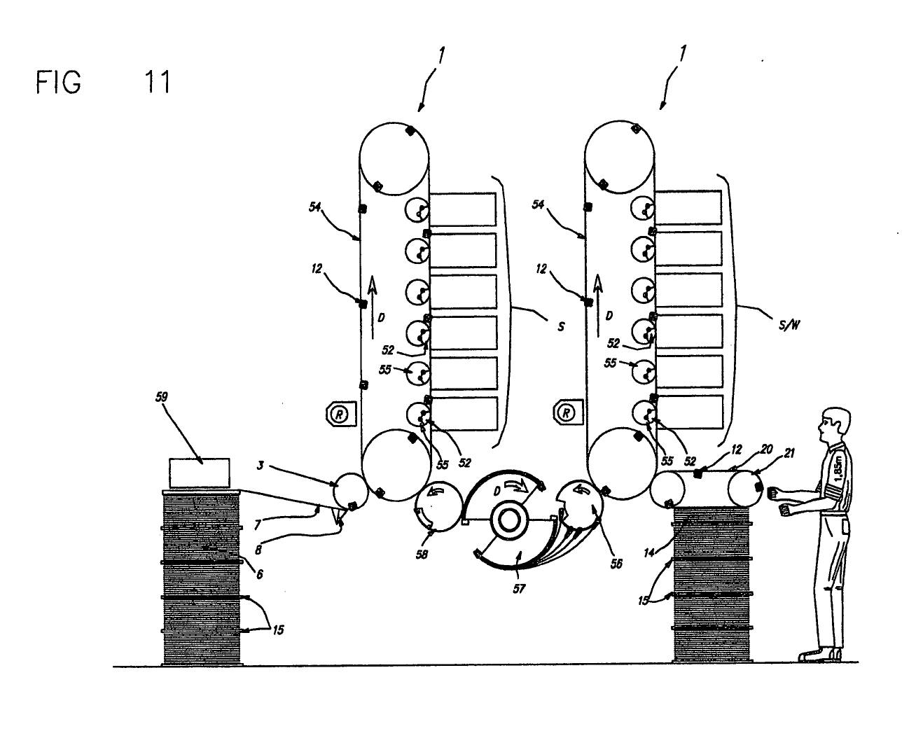

FIG. 12 shows a side view like FIG. 7 however with a sheet turnover system;

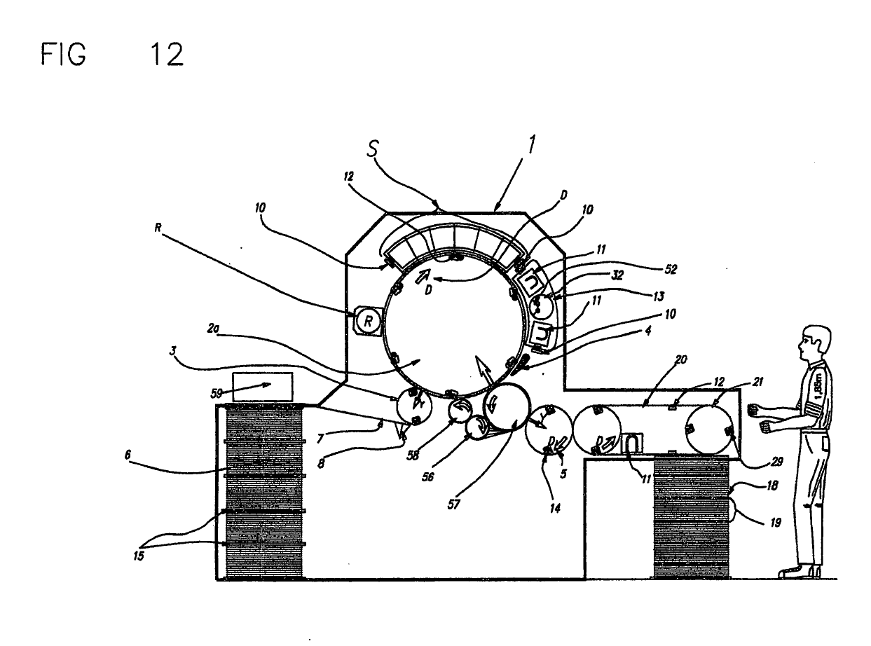

FIG. 13 shows a side view like FIG. 8 however with a sheet turnover system;

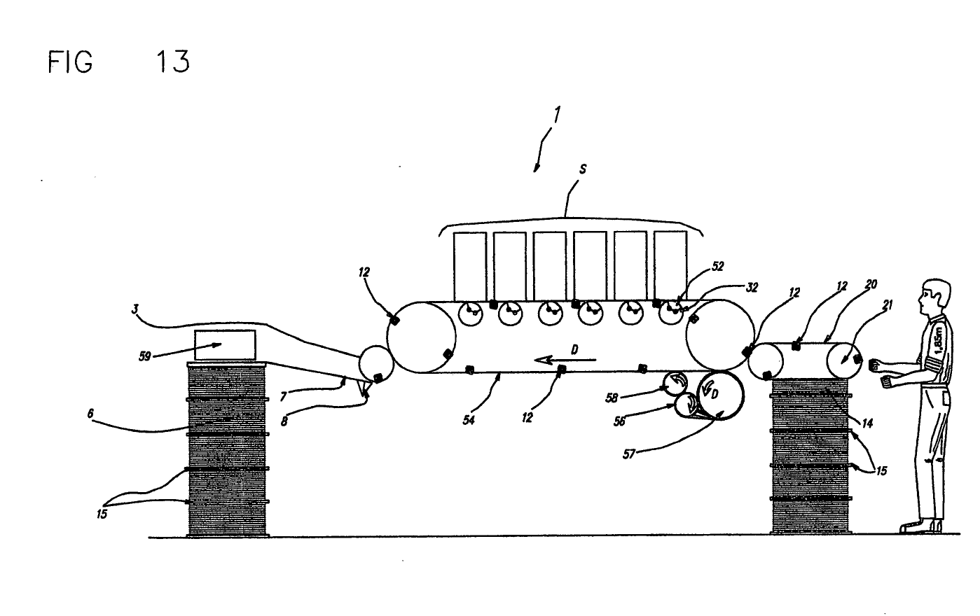

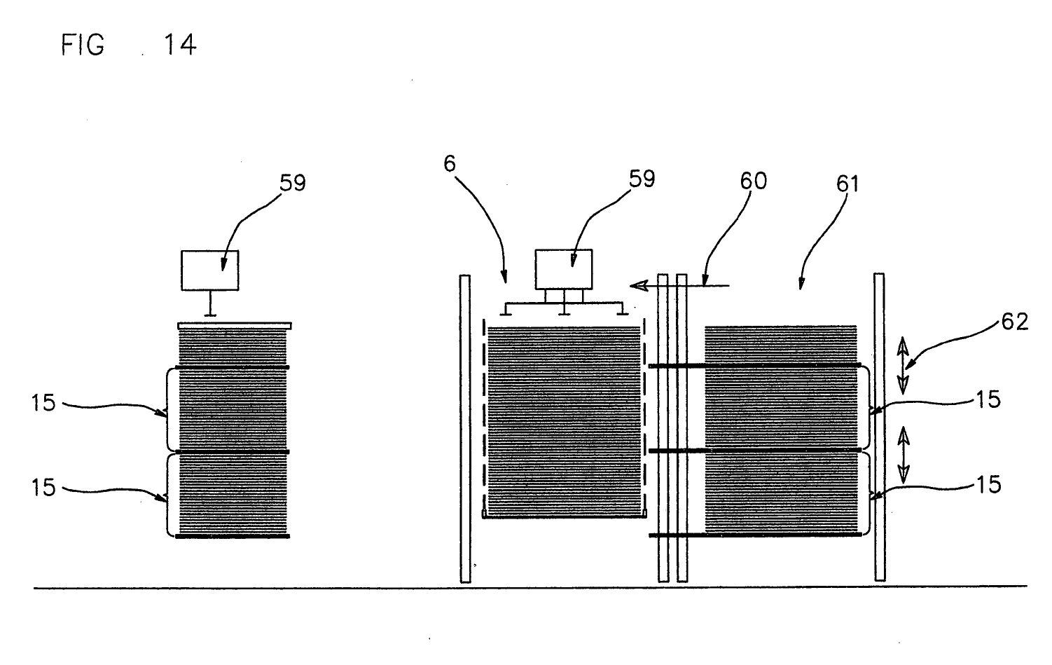

FIG. 14 shows a side view of the pre-loading device;

FIG. 15 shows an imaginary dual satellite printing press;

FIG. 16 shows an imaginary modular printing press, in series construction;

FIG. 17 shows a gripper system;

FIG. 18 shows a gripper system in a lowered position;

FIG. 19 shows a gripper system with transport cylinder covered with elastic material;

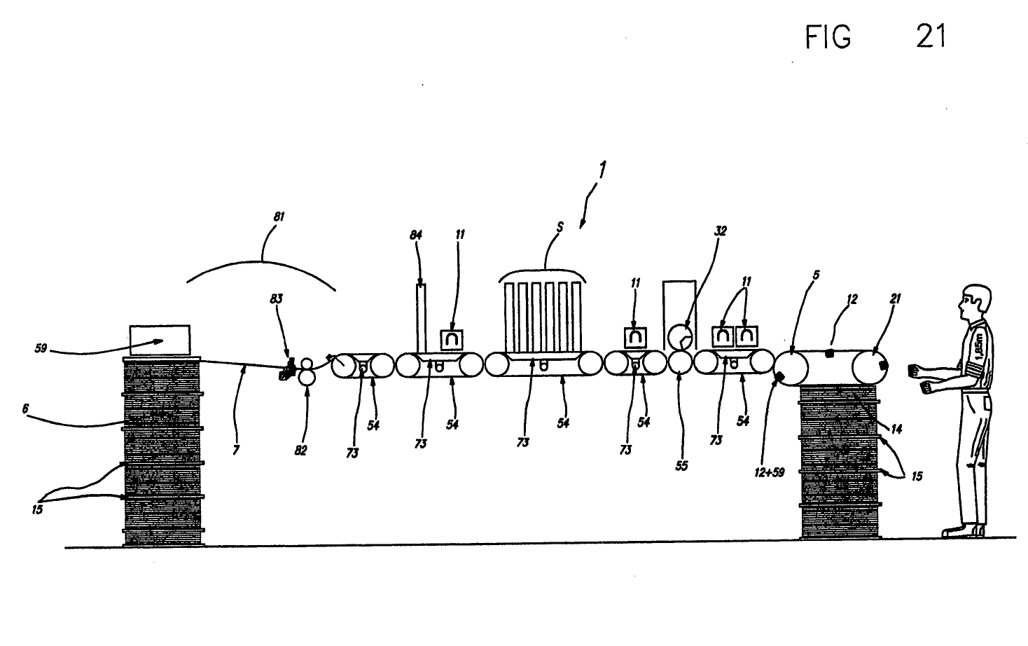

FIG. 20 shows a vacuum belt with vacuum-grippers;

FIG. 21 shows a transport device with multiple sections.

In FIG. 1 shows a satellite printing machine 1 featuring two transport cylinders 2a and 2b, with a cleaning system R and six satellite printing mechanisms S for multicolour, front-side printing. A downstream finishing cassette 13 is also shown.

The schematic illustration of the satellite printing machine 1 of FIG. 1 shows the preferred embodiment for sheet application, whereby feed cylinder 3 transport cylinders 2a and 2b and the delivery system 5 are equipped with gripper systems 12. The feed cylinder 3 has an upstream alignment table 7 which can be adjusted sideways, in height, in the feeding direction, and/or oblique to the feeding direction. Other means of adjustment (which are not shown) may be integrated in order to make the adjustments mentioned above. These adjustments can also be made during the production of the satellite printing press 1. The alignment table features vacuum belts with format related vacuum chambers in order to minimise the loss of energy (not shown).

The concept of machine 1 features a feed cylinder 3, transport cylinder 2a and 2b, imaging systems 40 (including color supply unit 41) and delivery cylinder 5, all with eccentric bushings for radial adjustment (arrow Y) during production, to adjust for different thicknesses of the material to be printed. Linear adjustment is also feasible.

FIG. 2 is like FIG. 1 however with enlarged upper transport cylinder 2a, so that additional cassettes for pre-print systems 9 e. g. for conditioning can be integrated. The post-print section shows a cassette 13 e. g. for finishing (e. g. lacquer application). It also shows the station for inline converting 46 which can be displaced according to arrow 6 for operation.

In an embodiment which is advantageous for operation of the machine 1, the supply system 3 and the delivery system 5 are disposed above a support plane at substantially the same height to define an approximately horizontal operation plane. Additional units for inline finishing or further processing may be provided in the region of the delivery system 5 and/or delivery chain 28 for further downstream processing using further guidance of printing material in a supply line for lacquering, drying, embossing, punching and the like. These heights permit simple loading and unloading of the machine 1 from the floor.

The multiple possibilities of delivery of intermediate processed sheets 48 or finished products 47, with preferred automatic batching, in combination with multiple possibilities of waste disposal (upwards 45, downwards 51 and inwards 50) are also shown.

FIG. 3 shows the support of one cassette unit for finishing 13 in the region of the machine frame. The cassette unit is thereby supported on rails 35 and 37 of respective side posts of the machine frame 33. The cassette unit 13 can be displaced in a parallel manner on these rails. It is also feasible to displace each satellite printing mechanism 5 together with these rails. In the embodiment shown, a linear ball bearing 34 or cam rollers 38 are provided for the respective rails and the rail 35 has a lower traverse. For positionally accurate displacement of the imaging systems 40 and 41 rails are connected via a support brace 36 such that they can be displaced next to the machine frame and can be returned into the working position without any distortion.

As shown in FIG. 4, the cassette units 39 e. g. for imaging each comprise an imaging device 40 and a color supply unit 41. After lifting Y from their printing position (FIGS. 3 and 4) on the transport cylinder the cassette units 13 can be displaced into a service position without requiring tilting of the cassette unit. This increases the position stability of the cassette units which permits printing with little vibration to eliminate printing distortions. FIG. 4 also shows the cassette positions in the machine frame, referred to in general with 42, wherein the cassette unit 39 is shown in the medium region, i.e. working position 42 and the right-hand side of the illustration shows that the cassette unit can be displaced parallel to the axis of rotation of the transport cylinder 2 into a lateral service position toward the operator side 43, next to the machine frame (arrow K, FIG. 4). The cassettes are also shown in a service position at the drive side 44.

The inventive cassette concept of the satellite printing machine 1 permits up to ten associated satellite printing mechanisms for front side printing S and up to ten satellite printing mechanisms for the backside printing W which may be directly adjacent to each other, in compact construction. The satellite machine is notably suited for full size duplex printing (front- and backside printing) of sheets whereby the gripper systems 12 require only one minimal gripper zone and therefore reduce the waste of paper.

FIGS. 5 and 6 show a schematic illustration of a drive concept in the region of the printing machine 1, the delivery system 14 and the device for die cutting 27. Two servo drive motors 18 and 19 are provided for securing a synchronous drive, each with a contact-free gearing 22, wherein the gearings also engage without contact at a constant separation 23 during the drive phase. The teeth abut only when a control error, e.g. a software error, could produce an undesired overload of the system, requiring immediate switching off of the drive force. This gearing 23 protects the system from damage, in particular the gripper systems, in a straightforward manner. The play-free gearing 24 provides synchronous motion of the male mold punching cylinder 24 and female mold punching cylinder 26.

FIG. 7 shows a schematic view like FIG. 1 however for single side printing (simplex printing).

FIG. 8 shows a digital printing machine 1 featuring a transport belt 54, a cleaning system R and six satellite printing mechanisms S for multicolor front side printing. It also shows upstream (pre-print) and downstream (post-print) Flexo letterpress cassettes 32 with two intermediate dryers 11 and two final dryers 11. The schematic view of FIG. 8 shows its use for sheets. The feed cylinder 3, the swing gripper 8 (alternatively the push feeder 81 with push rollers 82) the transport belt 54 and the delivery system 5 are provided with gripper system 12 and/or suckers 59. The feed cylinder 3 (alternatively the push feeder 8) has an upstream alignment table 7 as illustrated and explained in FIG. 1.

The difference between the pusher feeder 81 and the swing feeder 7 is that with the pusher feeder the sheets align, via the side lay stopper 83 and the pusher rolls 82, exactly and direct against the stopper 64. With the pusher feeder one does not need grippers and therefore no gripper recess clearances are required in the transfer drum 75.

The sheet is transferred by the transfer drum 75 with integrated vacuum system 73 and the vacuum grippers 64 by holding the sheet throughout is entire surface. The first flexo-letterpress printing unit is used e. g. for coating of a white layer for plastics and dried with an intermediate downstream dryer 11. Consecutively arranged are e. g. 6 inkjet heads who image the substrate in a non-contact fashion and, further downstream, a second dryer e. g. ultra violet for drying the image. A second flexo-printing unit is subsequently provided e. g. for a protective lacquer coating to be dryed with double final dryers. The transfer of the sheet is only effected after the complete sheet is printed in order to prevent distortion of the images by gripper transfer. This is the so called 7 o'clock position.

In the lower section of the belt system a cleaning system R is provided. The support rollers 55 function as indirect counter pressure cylinder for the Flexo-letterpress printing units, which conventionally work in contact and with pressure. These support rollers are format related and show a tensioning channel. The vacuum gripper systems have a limited field of application e. g. only for thin substrates for example office documents up to approx. max. of 250 grams per square meter. Not shown are the Anilox-rollers 30 and the enclosed doctor chambers 31 as they are illustrated and described in FIG. 3. It would be feasible that the vacuum chamber, in the printing area is of a slightly curved design (bent) for a optimal positioning of the substrate sheet (not shown).

FIG. 9 shows a schematic view like FIG. 7, however in a twin configuration with intermediate sheet turnover system, with turnover/transfer drum 56, 58 and turnover/storage drum 57. The drum 56 can be driven at different speeds.

FIG. 10 shows a schematic view, like FIG. 8, however with a conventional transport belt and a format related support roller per printing mechanism and a second downstream printing unit W for backside printing. The vacuum belts of FIG. 8 could be advantageous.

FIG. 11 shows a schematic view, like FIG. 10, however in a twin configuration with conventional sheet turnover systems 56, 57, 58 from FIG. 9. This turnover system can also be applied downstream of the printing machine (see FIG. 8).

FIG. 12 shows a schematic view, like FIG. 10, however with sheet turning device 56, 57, 58 from FIG. 9. In this configuration, duplex printing limits the production speed to 50% however the costs of investment are limited since only one set of printing mechanisms is required. The single set of printing mechanisms can adjust digitally to changed requirements for backside or front side imaging.

FIG. 13 shows a schematic view, like FIG. 7, however with sheet turnover system with its limitations as mentionned in the description of FIG. 12.

FIG. 14 shows a sheet feeder 6 with an adjacent pre-loading system 61. This allows the operator to load the sheet tray 15 during production. The sheet tray 15 is adjustable in height 62. At the moment of a job change, the new sheet tray can be automatically sideways 60 positioned in the feeder.

FIG. 15 shows a schematic printing machine of satellite construction based on FIG. 1 of U.S. Pat. No. 5,036,763. The schematic printing machine is extended to 2×7 printing mechanisms for Hi-Fi prints. The dimensions indicate that even the half-format B2 of his machine would have unrealistic operation dimensions compared to FIG. 2. The so-called S winding of the stop drum feed configuration 63 also fails to meet the requirements of minimum paper travel (straight path, minimised sheet guidance, or minimal bending of the sheet, respectively).

FIG. 16 shows a schematic printing machine of modular, series construction. A schematic configuration like FIG. 2 with 2×7 colors and lacquer mechanisms and inline further processing would produce completely unrealistic dimensions and therefore non-economical investment for a printing machine.

FIGS. 17, 18 and 19 show sectional illustrations with the sink-gripper systems. The gripper-shaft with sink-gripper 67, gripper-back 68, gripper-support plate 69, substrate 66, cylinder body 70 and eccentric command 71. The grippers are only slightly lowered and only during printing.

FIG. 17 shows the gripper system 67 in its working position towards the substrate 66, whereby the gripper-backs are situated above the cylinder surface and thereby limit the minimum distance of the digital printing mechanisms.

FIG. 18 shows the sink-gripper system 67 in a lowered fashion, exaggerated for better understanding. The gripper-backs 61 are now well below the cylinder surface thus allowing for the digital printing mechanisms to be set at a true minimum distance towards the material to be printed. This illustration, exaggerated for better understanding, shows the theoretical deformation of the substrate.

FIG. 19 shows the transport cylinder covered with a self adhesive rubber blanket. The characteristics of the elastic material allow for a maximum sinking of the grippers with minimal deformation of the material to be printed.

FIG. 20 shows the vacuum belt 54 with vacuum grippers and sinking stoppers 64. After the substrate 66 is aligned by the stopper, the substrate sheet is captured by the vacuum air 65 and secured to the transport belt. At the moment that the whole sheet is secured with vacuum, the stoppers 64 can be lowered (controlled by cam roller 38) and e. g. eccentric cam 71 or e. g. cam 80 in order to allow for a setting of minimum distance between the digital printing mechanisms e. g. Inkjet heads and the substrate to be printed. It also allows for a optimal air flow. The vacuum system will have a positive effect on this air flow which is critical with inkjet printing. Instead of one perforated vacuum belt, a set of perforated vacuum timing belts can also be used. It would be feasible to use stoppers with a oblique opening in the stopper 78 to allow for secure alignment.

The disadvantage hereby is that the sheet will have a slight deformation which however can be compensated for by the next transfer.

FIG. 21 shows a schematic illustration, like FIG. 8, however with a transportation system including several sections combining multiple belts and counter impression cylinders.
1. Satellite printing machine
2. transport cylinder
3. feed cylinder
4. compressed air support
5. delivery cylinder
6. sheet feeder
7. alignment table
8. swinging gripper
9. pre-print cassette
10. cassette guidance
11. dryer
12. gripper system
13. cassette unit e.g. for finishing
14. sheet delivery
15. substrate-cassette (sheet tray)
16. cylinder shell for heating
17. cassette-frame
18. drive of printing machine
19. servo drive converting station
20. delivery chain
21. chain wheel delivery
22. non-contact gear wheel drive
23. without gear contact
24. with backlash-free gear wheel drive
25. female mold punching cylinder
26. male mold punching cylinder
27. diecut-and score device
28. emboss- and foil-application device
29. sideframe-cassette
30. anilox roller
31. doctor blade (enclosed)
32. lacquer formroller
33. sideframe machine
34. open linear ball bearing
35. support rail with traverse
36. support brace
37. support rail
38. cam roller
39. imaging cassette
40. imaging system
41. color substrate supply unit
42. cassette in operation position
43. cassette in service position towards the operator side
44. cassette in service position towards the drive side
45. suction hood
46. inline converting station
47. delivery cut-outs
48. delivery for partially cut and/or finished sheets
49. waste disposal in upward direction
50. waste disposal in inward direction towards the cylinder interior
51. waste disposal in downward direction
52. tension channel
53. non-stop pile delivery
54. transport belt
55. support roller
56. sheet transfer- and turnover-cylinder with variable speed
57. turnover- and storage drum
58. transfer and turnover drum
59. suction head
60. sidelay
61. pre-loading device
62. height adjustment
63. stop drum system
64. vacuum gripper/stopper with lowering system
65. vacuum air opening
66. substrate to be printed
67. gripper on shaft
68. gripper back
69. gripper support plate
70. cylinder body
71. eccentric
72. elastic material (rubber blanket)
73. vacuum system e. g. vacuum drum or vacuum bar or vacuum chamber
74. 7 o'clock position
75. transfer drum
76. recess clearance in transport belt
77. bolt
78. oblique stopper
79. timing belt
80. cam
81. push feeder
82. push feeder rollers
83. side lay stopper

1-18. (canceled)

19. A digital printing machine for direct, non-contact printing of a sheet, the machine comprising:
at least one a digital printing mechanism having free format in a peripheral direction thereof;
a sheet transport system disposed downstream of said digital printing mechanism; and
grippers disposed at a periphery of said sheet transport system to hold the sheet.

20. The digital printing machine of claim 19, wherein a complete satellite printing mechanism is provided for each separate color and at least four individual colors are printed in one single machine pass for front side and/or backside printing.

21. The digital printing machine of claim 19, wherein a plurality of said digital printing mechanisms are disposed like satellites about said transport system.

22. The digital printing machine of claim 19, wherein said transport system is a format related transport cylinder.

23. The digital printing machine of claim 19, wherein said transport system is a format related transport belt.

24. The digital printing machine of claim 19, wherein said transport system comprises multiple transport cylinders, and/or transport belts, and/or counter impression cylinders.

25. The digital printing machine of claim 19, wherein said transport system comprises mechanical grippers which can be sunk at a defined location of a cylinder periphery.

26. The digital printing machine of claim 25, wherein said transport system is at least partially covered with elastic material and/or is equipped with resilient elements for lowering said grippers.

27. The digital printing machine of claim 19, wherein said transport system comprises vacuum-grippers with stoppers which can be lowered at a defined position of transport.

28. The digital printing machine of claim 19, wherein printing-mechanisms for front side and backside printing are arranged sequentially without an intermediate sheet turning device.

29. The digital printing machine of claim 19, further comprising a format-variable sheet turning device with at least one transfer cylinder which can be operated at differing speeds, said format variable sheet turning device disposed downstream of said transport system.

30. The digital printing machine of claim 19, wherein digital printing mechanisms for front side printing and back side printing have a same construction.

31. The digital printing machine of claim 19, further comprising a plurality of additional printing systems having printing operation without format and/or predetermined format with integrated counter pressure cylinder for cleaning, conditioning, coating, fixing, drying and/or renewed moistening.

32. The digital printing machine of claim 19, wherein said transport system has identical dimensions for front side printing and for backside printing.

33. The digital printing machine of claim 19, wherein said transport system has different dimensions for front side printing and for backside printing.

34. The digital printing machine of claim 19, further comprising compressed air- and/or vacuum systems for optimal sheet transport and flat sheet positioning cooperating with at least one of transport system transfer cylinders, a feeder, and a delivery mechanism.

35. The digital printing machine of claim 23, wherein said transport belt is supported by format related rollers with recesses for accepting grippers at a periphery thereof.

36. The digital printing machine of claim 19, further comprising conditioning cassettes, wherein said printing mechanisms and said conditioning cassettes each form cassette inserts which can be displaced towards an operating and/or drive side from a working position into a service position.
